(19) United States
(12) Patent Application Publication
(10) Pub. No.: US 2019/0315550 A1
(43) Pub. Date: Oct. 17, 2019

(54) INSTA-MIX CUP

(71) Applicants: Alejandro Romo, Peoria, AZ (US); Guadalupe Romo, Peoria, AZ (US)

(72) Inventors: Alejandro Romo, Peoria, AZ (US); Guadalupe Romo, Peoria, AZ (US)

(21) Appl. No.: 16/382,159

(22) Filed: Apr. 11, 2019

Related U.S. Application Data
(60) Provisional application No. 62/656,347, filed on Apr. 11, 2018.

(51) Int. Cl. B65D 81/32; C12G 3/06; B65D 25/04; B65D 85/816; A47J 43/27

(52) U.S. Cl. CPC B65D 81/3216; C12G 3/06; A47J 43/27; B65D 85/816; B65D 25/04

(57) ABSTRACT

The present invention relates to an inventive apparatus and a method for creating mixed drinks on-the-go. The apparatus includes two or more chambers for storing pre-measured ingredients separately. The apparatus also includes a mechanism for mixing the separated ingredients at a desired time. The mechanism ensures that the drink is mixed only at a time that the user desires and around the time that the user intends to consume the mixed drink.

### CROSS-REFERENCE TO RELATED APPLICATIONS

This application claims priority to U.S. Provisional Patent Application Ser. No. 62/656,347, filed Apr. 11, 2018 entitled “Insta-Mix Cup.” The entire content of that application is incorporated herein by reference.

### BACKGROUND

### Field of the Art

This disclosure relates to an apparatus for mixing a beverage. More specifically, the apparatus of the present disclosure if for separately storing various ingredients to make a beverage, and a mechanism for blending the ingredients together for a freshly mixed beverage that may be consumed directly from the apparatus without the aid of any additional drinkware.

### Discussion of the State of the Art

Making mixed drinks that require two or more ingredients is not an easy process. It requires the maker/user to gather various ingredients, measure them appropriately, chop them up as appropriate, gather mixing vessels, and mix the materials together.

This process is made even more difficult when a maker/user wants to make the mixed drink on-the-go where the user may not have ready access to all of the ingredients, chopping materials, measuring equipment, storage containers, mixing vessels, and drinking vessels. Because of these difficulties, users or consumers are often willing to be pay exorbitant premiums for a mixed drink on-the-go, such as at airport lounges or bars, resorts, sporting events, etc. In some other circumstances, such as during commercial air travel or in an airplane, where some of the ingredients may be too difficult to preserve or inventory, consumers don't even have an option to purchase or consume a mixed drink.

Moreover, making mixed drinks is often an expensive and wasteful endeavor because it requires makers/users to purchase ingredients in bulk or in large quantities and then discard the unused portions. For example, if a user wishes to make only one or two mixed drinks, the user must, nonetheless, purchase quantities of the underlying ingredients in whichever sizes or portions that are typically sold at retail outlets. Often, these portions or quantities are much greater than the quantities a user needs to make a few mixed drinks. This effectively raises the cost of making a mixed drink-often significantly. Moreover, it also generates waste to the extent that a user must discard ingredients if they are perishable and won't be used before they expire, or if the user doesn't have appropriate mechanism for storing the left-over ingredients.

Some have tried to solve these problems by selling pre-mixed drinks that are mixed at a manufacturing or packaging facility. But these pre-mixed drinks often taste nothing like drinks that are mixed with fresh ingredients or freshly mixed together. As a result, pre-mixed drinks don't represent a real solution, or a real alternative to enjoying mixed drinks on-the-go.

### SUMMARY

The present invention relates to an inventive apparatus and a method for creating mixed drinks on-the-go. The apparatus includes two or more chambers for storing pre-measured ingredients separately. The apparatus also includes a mechanism for mixing the separated ingredients at a desired time. This mechanism ensures that the drink is mixed only at a time that the user desires and around the time that the user intends to consume the mixed drink. Additionally, the apparatus includes a mechanism for ensuring that the ingredients are mixed together in a manner that the user desires. For example, the apparatus may include a shaker mechanism for shaking the mixed drink or a stirring mechanism for stirring the mixed drink as desired. Finally, the apparatus may also include an enclosure mechanism for ensuring that the ingredients remain fresh at the time of mixing, and to also ensure that the ingredients don't spill out during the shipping and sales process.

The inventive apparatus described herein may be used in wide variety of applications. One specific application includes making alcoholic mixed drinks. In this particular application, at least one chamber of the two or more separation chambers may include a spirit, such as whisky, vodka, tequila, etc. At least one other chamber of the two or more separation chambers may include ingredients that ma) be mixed with the spirit, such as soda, chopped mint, chopped or whole berries, bitters, sugar, seasoning mix, etc. The user may mix these two or more ingredients together by removing an enclosure, and using the provided mixing mechanism, such as an outer shaker cup that couples with an interior cup containing the mixing chamber. By using the apparatus in this manner, a user may mix or create a mixed alcoholic beverage that contains desired ingredients in a desired ratio- and is also freshly mixed for consumption.

The inventive apparatus described herein may also be used for mixing other types of items as well. For example, the inventive apparatus may be used to freshly mix protein shakes, formula, soups, and other food items. Indeed, the invention described herein is not limited to any particular application or use case. It may be used for a variety of applications that require freshly mixing two or more ingredients together.

### BRIEF DESCRIPTION OF THE DRAWING FIGURES

The accompanying drawings illustrate several embodiments and, together with the description, serve to explain the principles of the invention according to the embodiments. It will be appreciated by one skilled in the art that the particular arrangements illustrated in the drawings are merely exemplary and are not to be considered as limiting of the scope of the invention or the claims herein in any way.

FIG. 1 illustrates the inventive apparatus for making a mixed drink on-the-go, according to one embodiment of the invention.

FIG. 2A illustrates an interior cup and an exterior cup of the inventive apparatus for making a mixed drink on-the-go, according to one embodiment of the invention.

FIG. 2B illustrates a first mechanism for coupling an interior and an exterior cup of the inventive apparatus for making a mixed drink on-the-go, according to one embodiment of the invention.

FIG. 2C illustrates a second mechanism for coupling an interior and exterior cup of the inventive apparatus for making a mixed drink on-the-go, according to one embodiment of the invention.

FIG. 3A illustrates, from a side view, a separation mechanism within an interior cavity of the inventive apparatus for making a mixed drink on-the-go, according to one embodiment of the invention.

FIG. 3B illustrates, from a top view, a separation mechanism within an interior cavity of the inventive apparatus for making a mixed drink on-the-go, according to one embodiment of the invention.

FIG. 4 illustrates a separation mechanism and a lid of the inventive apparatus for making a mixed drink on-the-go, according to one embodiment of the invention.

### DETAILED DESCRIPTION

The invention disclosed herein is for an apparatus for separately storing ingredients for making a mixed beverage and for mixing the various ingredients together to make a mixed beverage, the apparatus comprising an exterior cup configured to hold a volume of liquid in an interior volume, an interior cup configured to couple with the exterior cup in a nesting configuration and a shaker-cup configuration, a partition within an interior volume of the interior cup, the partition subdividing the interior volume of the interior cup into at least two sub-chambers, each sub-chamber configured to separately house at least one ingredient for making a mixed beverage, and a removable closure mechanism configured to prevent ingredients in one sub-chamber from mixing with ingredients in another sub-chamber when the closure mechanism is in a closed position, the removable closure mechanism further configured to permit ingredients in one sub-chamber to mix with ingredients in another sub-chamber when the closure mechanism is in an open position.

In one embodiment of the invention, the exterior cup of the apparatus may be further comprised of a rim that disposed around opening of the exterior cup, and the interior cup may be comprised of a rim that is disposed around the opening of the interior cup. The apparatus may be further comprised of a lid, wherein the lid may be removably attached to the exterior cup's rim and/or the interior cup's rim.

In one embodiment of the invention, the interior cup fits within the interior volume of the exterior cup when the cups are coupled in a nesting configuration. Moreover, the rim of the interior cup may or may not extend beyond the rim of the exterior cup when the interior cup is placed within the interior volume of the outer cup in a nesting configuration.

In a same embodiment of the invention, the rim of the exterior cup couples to the rim of the interior cup when the cups are coupled in a shaker-cup configuration. More specifically, the interior cup is outside the interior volume of the exterior cup in a shaker-cup configuration. Moreover, the cups form leak proof seal when the cups are coupled in a shaker-cup configuration.

In one embodiment of the invention, each sub-chamber of the inventive apparatus is vacuum sealed to preserve the freshness of ingredients that may be housed within the sub-chamber. For example, in one embodiment, after a sub-chamber is filled with at least one ingredient, the closure mechanism may be affixed to the sub-chamber in a manner that creates a vacuum or a substantial vacuum within the sub-chamber. The vacuum may be removed when a user peels-off or removes the closure mechanism.

In one configuration, each sub-chamber is pre-filled with at least one ingredient. This configuration enables a user to quickly and easily make and consume a freshly mixed beverage without having to gather ingredients, measure the appropriate or required amount, and chop and/or otherwise modify the ingredients to make a mixed drink. In one example, a first sub-chamber may pre-filled with a spirit ingredient, including, but not limited to an alcohol such as whisky, gin, vodka, etc. In one configuration two or more different spirits may be pre-filled in a first sub-chamber. A second sub-chamber may be pre-filled with at least a liquid mixer ingredient, including, but not limited to simple syrups, citrus juices, liquors, etc. A third sub-chamber may be pre-filled with at least a dry mixer ingredient, including, but not limited to seasoning mix, salt, chili powder, etc. Additional sub-chambers may be pre-filled with additional one or more ingredients without departing from the scope of the invention.

In one embodiment of the invention, the entire apparatus is disposable. Specifically, the exterior cup, the interior cup, and the removable closure mechanisms are disposable so that a user may discard the entire apparatus after mixing and consuming the mixed beverage. This feature of the invention permits the apparatus to be sold in various retail settings where the user may be on the go, such as airport lounges, airplanes, sporting venues, entertainment venues, etc.

In accordance with an aspect of the invention, ingredients housed in a sub-chamber may travel to the interior volume of the exterior cup when the cups, coupled in a shaker-cup configuration, are shaken together by a user, the shaking causing the ingredients in the sub-chambers to mix with each other along with material that may have be placed in the interior volume of the exterior cup.

In one embodiment of the invention the removable closure mechanism is comprised of a removable barrier that is removably affixed to a portion of the interior cup and/or the partition. For example, the removable closure mechanism may be affixed to a portion of interior cup and/or the partition via a removable adhesive.

In one embodiment of the invention, the partition is removable from the interior volume of the interior cup.

The apparatus may be further comprised of a coupling enclosure that enables the exterior cup to couple with the interior cup in a shaker-cup configuration. For example, the coupling enclosure couples to the exterior cup on one end and the exterior cup on the other end. The coupling enclosure may be further comprised of at least one pass-through aperture that permits ingredients to travel between the two cups when the cups are in a shaker-cup configuration and shaken together.

Generally, one or more different embodiments may be described in the present application. Further, for one or more of the embodiments described herein, numerous alternative arrangements may be described; it should be appreciated that these are presented for illustrative purposes only and are not limiting of the embodiments contained herein or the claims presented herein in any way. One or more of the arrangements may be widely applicable to numerous embodiments, as may be readily apparent from the disclosure. In general, arrangements are described in sufficient detail to enable those skilled in the art to practice one or more of the embodiments, and it should be appreciated that other arrangements may be utilized and that structural changes may be made without departing from the scope of the embodiments. Particular features of one or more of the embodiments described herein may be described with reference to one or more particular embodiments or figures that form a part of the present disclosure, and in which are shown, by way of illustration, specific arrangements of one or more of the aspects. It should be appreciated, however, that such features are not limited to usage in the one or more particular embodiments or figures with reference to which they are described. The present disclosure is neither a literal description of all arrangements of one or more of the embodiments nor a listing of features of one or more of the embodiments that must be present in all arrangements.

Headings of sections provided in this patent application and the title of this patent application are for convenience only and are not to be taken as limiting the disclosure in any way.

Devices and parts that are connected to each other need not be in continuous connection with each other, unless expressly specified otherwise. In addition, devices and parts that are connected with each other may be connected directly or indirectly through one or more connection means or intermediaries.

A description of an aspect with several components in connection with each other does not imply that all such components are required. To the contrary, a variety of optional components may be described to illustrate a wide variety of possible embodiments and in order to more fully illustrate one or more embodiments. Similarly, although process steps, method steps, or the like may be described in a sequential order, such processes and methods may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the embodiments, and does not imply that the illustrated process is preferred. Also, steps are generally described once per aspect, but this does not mean they must occur once, or that they may only occur once each time a process, or method is carried out or executed. Some steps may be omitted in some embodiments or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other embodiments need not include the device itself.

Techniques and mechanisms described or referenced herein will sometimes be described in singular form for clarity. However, it should be appreciated that particular embodiments may include multiple iterations of a technique or multiple instantiations of a mechanism unless noted otherwise. Alternate implementations are included within the scope of various embodiments in which, for example, functions may be executed out of order from that shown or discussed, including substantially concurrently or in reverse order, depending on the functionality involved, as would be understood by those having ordinary skill in the art.

### Overview

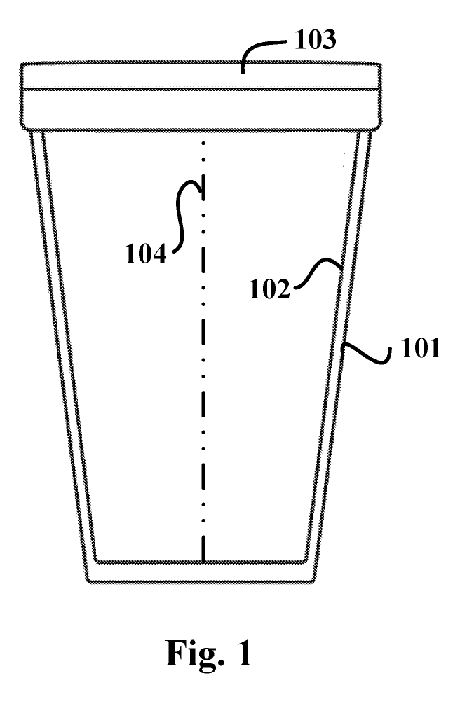

An exemplary embodiment of the inventive apparatus described herein is illustrated in FIG. 1. It includes an exterior cup 101, and interior cup 102, a lid 103, a partition 104, and a coupling mechanism 105. The various features connect inter-connect, and couple in various ways to help users create freshly mixed mixed-drinks as described in greater detail below.

Generally, the exterior cup 101 houses the interior cup 102 in a nesting configuration, and couples with the interior cup in a shaker cup configuration. The interior cup contains one or more separation chambers, which may be created by using a partition or a partition 104. Beverages, spirits, and other ingredients may be separately stored in the one or more chambers. The interior cup 102 may be coupled to the exterior cup 101 in a shaker cup configuration to allow a user to mix the various ingredients in the two or more chambers by shaking the coupled cups together. The apparatus also includes a lid 103 that helps ensure that the ingredients do not mix until a user desires to mix them. Moreover, the lid 103 may also serve as a coupling mechanism for coupling the interior cup 102 with the exterior cup 101.

### Interior and Exterior Cups

In one embodiment, the inventive apparatus includes an exterior cup 101, and an interior cup 102. The two cups serve as a mechanism for housing the ingredients used for creating a mixed-drink, and as a mechanism for mixing the ingredients together. Moreover, the cups couple together in the manner described below.

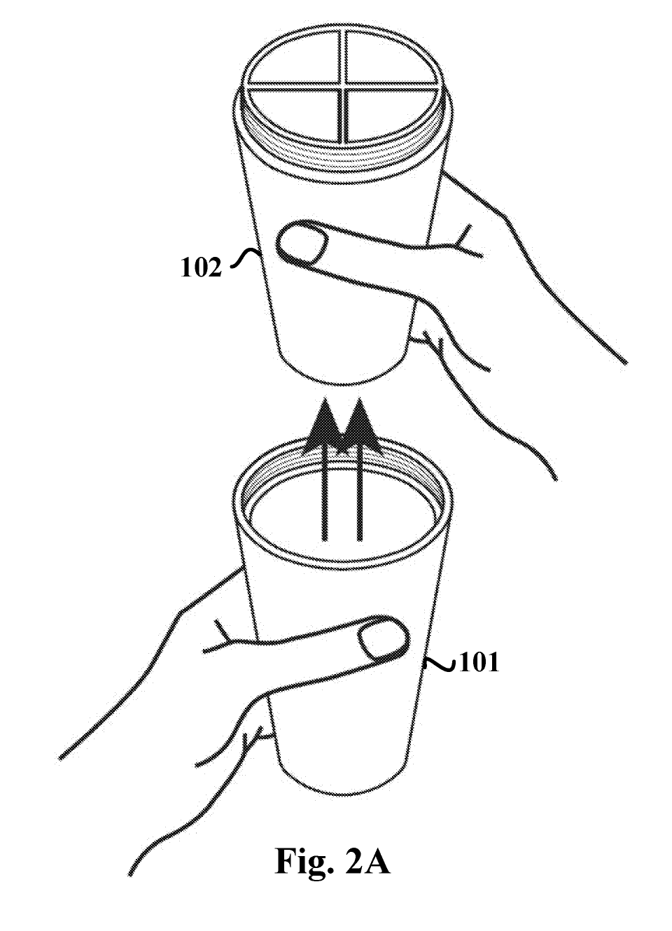

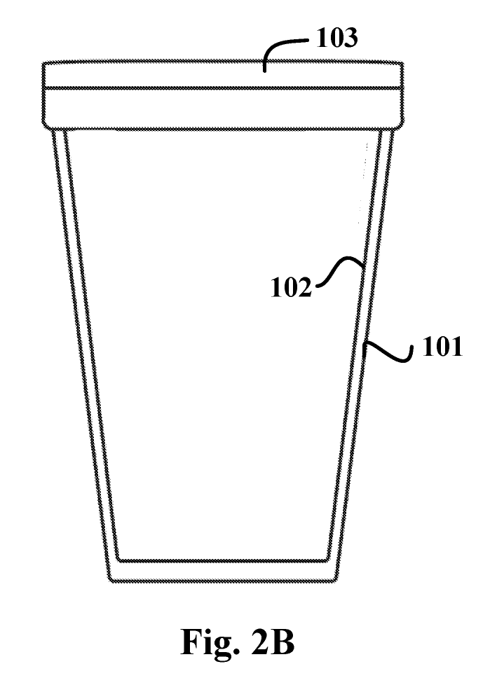

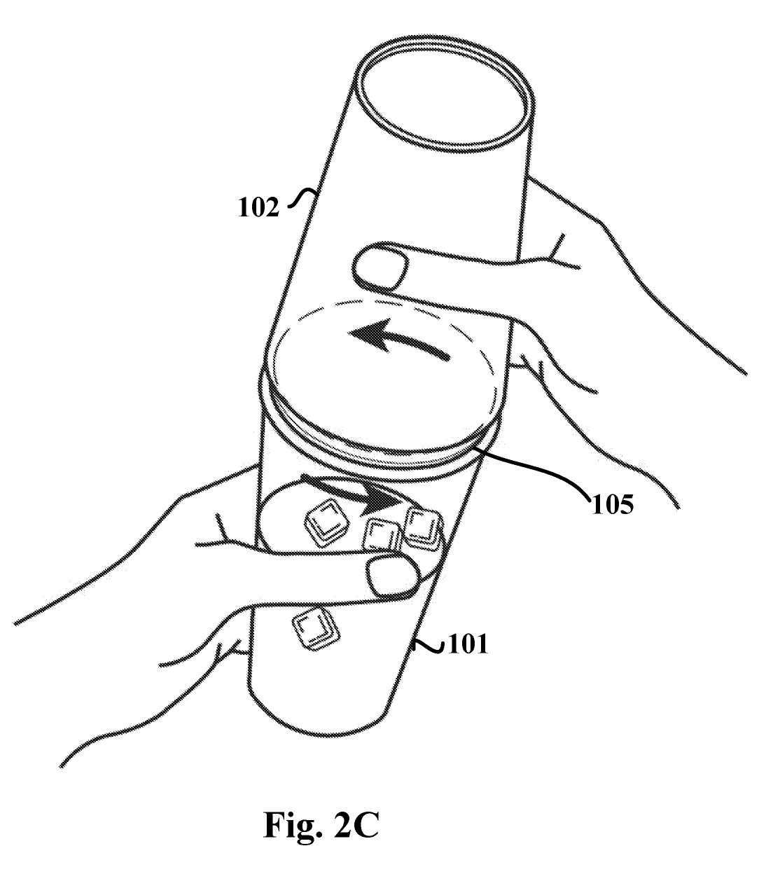

FIG. 2A illustrates an exemplary embodiment of the interior cup 102, and FIG. 2A illustrates an exemplary embodiment of the exterior cup 101. The shapes and sizes that are illustrated in FIGS. 1-2 are for illustrative purposes only. The interior 102 and exterior 101 cups may be shaped in a variety of shapes and sizes (to the extent that they perform the functionality described herein) without departing from the scope of the invention.

### Mechanism for Coupling Interior and Exterior Cups

The interior 102 and exterior 101 cups may be coupled in at least two ways, as illustrated in FIGS. 2B (nesting configuration) and 2C (shaker cup configuration).

In a first instance, as illustrated in FIG. 2B, the cups may be coupled in nested configuration, wherein, the interior cup 102 sits, at least partially, within the interior cavity of the exterior cup 101. The nesting configuration allows for easy packing, shipping, and storage of the two containers. For example, the two containers may be shipped and sold in a nesting configuration. This reduces costs by reducing the size of the shipped unit, and also improves inventory management by taking up less space in either retail shelf-space or in back-end bulk storage space. The nesting configuration also allows ultimate consumers to use the inventive apparatus without dealing with a number of separate pieces. It also provides a better user experience to those who are on the go, or don't have a lot of room, such as customers in commercial airplanes, etc.

In one embodiment of the invention, the interior cup 102 partially extends beyond the exterior cup 101 while in a nested stated. For example, as shown in FIG. 2B, the top portion of the interior cup 102 may extend beyond the topmost part of the exterior cup 101. In such an embodiment, a lid or an enclosure mechanism 103 may couple to the interior cup 102. In other embodiments, the two cups may have the same height, or the interior cup 102 may extend below the exterior cup 101 when the two cups are coupled together in a nesting configuration. In these embodiments, the lid or an enclosure mechanism 103 may couple to either the interior cup 102 or the exterior cup 101.

The two cups also couple together in a shaker cup configuration, as illustrated in FIG. 2C. The shaker cup configuration permits a user to mix together the ingredients that are housed within the interior cup 102. In embodiment illustrated herein in FIG. 2C, the user may mix the ingredients by shaking them within the two cups once they are in the shaker cup configuration. The shaker cup configuration permits users to vigorously mix ingredients together, permits a user to create froth for the mixed beverage, as desired or appropriate, permits the user to add ice and other ancillary ingredients as desired, and eliminates the need for other utensils such as stirring straws, spoons, etc., which may not be readily available on the go.

In one embodiment of the invention, the exterior cup 101 interior 102 cups are coupled together in a shaker cup configuration by the use of a coupling mechanism 105. In one embodiment, the coupling mechanism may comprise of complimentary threaded screws on lip of each cup. For example, the two cups may be coupled by rotating the cups around the threads until they are locked. This is only one mechanism for coupling the two cups in this configuration. But other coupling mechanisms 105, which may be known to persons of ordinary skill in the art, may be used without departing from the scope of the invention, including, but not limited to: snapping the two cups together through the use of complimentary grooves, jamming the two cups together similar to a martini shaker, etc.

### Partition

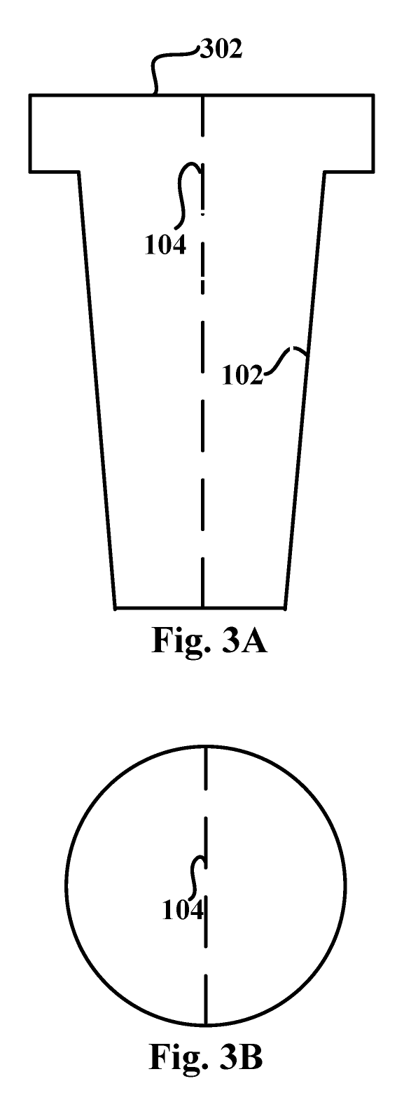

The inventive apparatus also includes a partition 104, as illustrated in FIGS. 3a and 3b The partition 104 sub-divides the interior cavity of the interior cup 102 in such a manner that ingredients, which are used to make a mixed drink, do not mix until a user desires to mix the ingredients. In one embodiment, the partition 104 may create an air sealed chamber that keeps ingredients fresh or keeps the carbon dioxide in carbonated beverages from dissolving.

In FIGS. 3A and 3B the partition 104 subdivides the interior cavity of the interior cup 102 in two sub-cavities. But, additional subdivision is contemplated and considered a part of the inventive concept disclosed herein. For example, the partition 104 may subdivide the interior cavity in any number of sub-cavities as a may be required to house the ingredients needed to created a mixed drink. For example, if a mixed drink requires eight ingredients, the interior cavity of the interior cup 102 may be subdivided into 8 chambers.

Although FIGS. 3A and 3B illustrate a partition 104 that subdivides the interior cavity of the interior cup 102 in a vertical orientation, a partition that subdivides the interior surface in other orientations is also contemplated and considered a part of the inventive concept disclosed herein. For example, the partition 104 may subdivide the interior cavity in a number of orientations without departing from the scope of the invention, including, but not limited to, vertically, horizontally, vertically and horizontally in combination, or any other orientation that may be understood by a person of ordinary skill in the art.

In one embodiment, the partition 104 may be removable. In other embodiments, however, the partition 104 may be affixed to the interior cavity of the interior cup 102. For example, the partition 104 may be a wall that is molded into the interior cavity of the interior cup 102. In such embodiments, the apparatus may also include a mechanism for allowing the ingredients to mix when the user desires to mix them. For example, the partition 104 may be collapsible. In other embodiments, as described in greater detail below, removing the lid 103 permits the ingredients to mix together.

### Lid

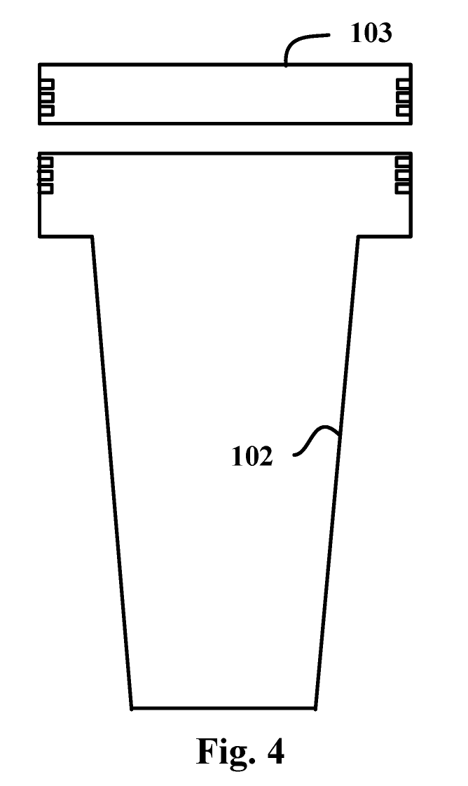

FIG. 4 illustrates a lid, or an enclosure mechanism 103 in accordance with one embodiment of the invention. The lid 103 ensures that the ingredients, which are stored in the interior cup 102, do not spill out. In some embodiments, the lid 103 also serves as a pathway for allowing the ingredients to mix once the lid 103 is opened. In other embodiments yet, as described above in greater detail, the lid creates pathways for permitting the ingredients to move from the interior cup 102 to the exterior cup 101 when the two cups are coupled together in a shaker cup configuration.

In one embodiment, the lid 103 is a screw-top lid that couples to corresponding threads on the interior 102 or the exterior cup 101. In other embodiments, the lid 103 may be “peel-apart” paper or plastic lid that is glued to the exterior lip of the interior 102 or the exterior cup 101. Other enclosure mechanisms may be used without departing from the scope of the invention, including, but not limited to, push-pull lids, snap-on lids, etc. A multi-ring lid with apertures, of one embodiment of the invention, is described in more detail above. In some embodiments, as desired, the lid may help create a vacuum seal within one or more interior chambers of the interior cup 102.

In one embodiment, a lid or an enclosure mechanism 103 may be used to couple the two cups together in a nesting configuration.

In such an embodiment, the lid 103 couples to the interior cup 102 on one end, and, at the same time, an exterior cup 101 on the other end. The lid 103 may also include one or more pass-through apertures that permit ingredients to travel between the two cups when the cups are shaken together for mixing purposes. The apertures may be circular, similar to the ones seen in martini shakers/mixers. However, other types of pass-through elements may be used without departing from the scope of the invention.

In one embodiment, the pass-through apertures may be opened or closed by a user. A variety of different mechanisms may be used for opening or closing the apertures without departing from the scope of the invention, including, but not limited to: using two separate “layers,” each of which has a set of apertures that may align in an “open” setting, and disjoin in a closed configuration. In such an embodiment, the ingredients in the cups may freely pass through the aligned apertures in an open setting, but do not pass through the disjoined apertures in a closed setting. Further, in one embodiment, the lid 103 may be placed in an open or closed setting by the user through a provided slider. However, other mechanisms for permitting a user to open or close the apertures may be used without departing from the scope of the invention.

### Additional Considerations

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has.” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary. “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and a process for creating an interactive message through the disclosed principles herein. Thus, while particular embodiments and applications have been illustrated and described, it is to be understood that the disclosed embodiments are not limited to the precise construction and components disclosed herein. Various apparent modifications, changes and variations may be made in the arrangement, operation and details of the method and apparatus disclosed herein without departing from the spirit and scope defined in the appended claims.

What is claimed is:

1. An apparatus for separately storing ingredients for making a mixed beverage and for mixing the various ingredients together to make a mixed beverage, the apparatus comprising:
an exterior cup configured to hold a volume of liquid in an interior volume;
an interior cup configured to couple with the exterior cup in a nesting configuration and a shaker-cup configuration;
a partition within an interior volume of the interior cup, the partition subdividing the interior volume of the interior cup into at least two sub-chambers, each sub-chamber configured to separately house at least one ingredient for making a mixed beverage; and
a removable closure mechanism configured to prevent ingredients in one sub-chamber from mixing with ingredients in another sub-chamber when the closure mechanism is in a closed position, the removable closure mechanism further configured to permit ingredients in one sub-chamber to mix with ingredients in another sub-chamber when the closure mechanism is in an open position.

2. The apparatus of claim 1, wherein the exterior cup is further comprised of a rim that disposed around opening of the exterior cup, and the interior cup is further comprised of a rim that is disposed around the opening of the interior cup.

3. The apparatus of claim 2 further comprising a lid, wherein the lid may be removably attached to the exterior cup's rim.

4. The apparatus of claim 2 further comprising a lid, wherein the lid may be removably attached to the interior cup's rim.

5. The apparatus of claim 2, wherein the interior cup fits within the interior volume of the exterior cup when the cups are coupled in a nesting configuration.

6. The apparatus of claim 5, wherein the rim of the interior cup extends beyond the rim of the exterior cup when the interior cup is placed within the interior volume of the outer cup in a nesting configuration.

7. The apparatus of claim 2, wherein the rim of the exterior cup couples to the rim of the interior cup when the cups are coupled in a shaker-cup configuration.

8. The apparatus of claim 7, wherein the interior cup is outside the interior volume of the exterior cup in a shaker-cup configuration.

9. The apparatus of claim 7, wherein the cups form leak proof seal when the cups are coupled in a shaker-cup configuration.

10. The apparatus of claim 7, wherein ingredients housed in a sub-chamber may travel to the interior volume of the exterior cup when the cups, coupled in a shaker-cup configuration, are shaken together by a user, the shaking causing the ingredients in the sub-chambers to mix with each other along with material that may have be placed in the interior volume of the exterior cup.

11. The apparatus of claim 1, wherein the removable closure mechanism is comprised of a removable barrier that is removably affixed to a portion of the interior cup.

12. The apparatus of claim 11, wherein the removable closure mechanism is affixed to a portion of interior cup via a removable adhesive.

13. The apparatus of claim 1, wherein the removable closure mechanism is comprised of a removable barrier that is removably affixed to a portion of the partition.

14. The apparatus of claim 13, wherein the removable closure mechanism is affixed to a portion of the partition via a removable adhesive.

15. The apparatus of claim 1, wherein the partition is removable from the interior volume of the interior cup.

16. The apparatus of claim 1, wherein a coupling enclosure enables the exterior cup to couple with the interior cup in a shaker-cup configuration.

17. The apparatus of claim 16, wherein the coupling enclosure couples to the exterior cup on one end and the exterior cup on the other end.

18. The apparatus of claim 17, wherein the coupling enclosure is further comprised of at least one pass-through aperture that permits ingredients to travel between the two cups when the cups are in a shaker-cup configuration and shaken together.

19. The apparatus of claim 1, wherein each sub-chamber is vacuum sealed to preserve the freshness of ingredients that may be housed within the sub-chamber.

20. The apparatus of claim 19, wherein each sub-chamber is pre-filled with at least one ingredient.

21. The apparatus of claim 20, wherein a first sub-chamber is pre-filled with a spirit ingredient.

22. The apparatus of claim 20, wherein a second sub-chamber is pre-filled with at least a liquid mixer ingredient.

23. The apparatus of claim 20, wherein a third sub-chamber is pre-filled with at least a dry mixer ingredient.

24. The apparatus of claim 23, wherein the exterior cup and interior cup are disposable.
